(19) United States
(12) Patent Application Publication
(10) Pub. No.: US 2016/0197749 A1
(43) Pub. Date: Jul. 7, 2016

(54) WIRELESS COMMUNICATION SYSTEM, METHOD FOR WIRELESS COMMUNICATION, AND TRANSMITTER

(71) Applicant: FUJITSU LIMITED, Kawasaki-shi (JP)

(72) Inventor: Tsuyoshi Hasegawa, Kawasaki (JP)

(73) Assignee: FUJITSU LIMITED, Kawasaki-shi (JP)

(21) Appl. No.: 14/986,752

(22) Filed: Jan. 4, 2016

(30) Foreign Application Priority Data
Jan. 5, 2015 (JP) 2015-000216

(51) Int. Cl. H04L 27/00; H04J 11/00; H04B 7/04; H04L 5/00

(52) U.S. Cl. CPC H04L 27/0006; H04L 5/0007; H04J 11/005; H04B 7/0408

(57) ABSTRACT

A wireless communication system includes: a plurality of transmitting antennas; one or more receiving antennas; and a controller. The controller controls, based on a weight matrix, a weight on a signal to be transmitted from the plurality of transmitting antennas, the weight matrix coming to be a null matrix when being multiplied by a block matrix, the block matrix having, as blocks, a plurality of matrices obtained by selecting elements corresponding to a number of the plurality of transmitting antennas from a channel matrix. The channel matrix represents a plurality of propagation channels between the plurality of the transmitting antennas and the one or more receiving antennas.

### CROSS-REFERENCE TO RELATED APPLICATION

This application is based upon and claims the benefit of priority of the prior Japanese Patent application No. 2015-000216, filed on Jan. 5, 2015, the entire contents of which are incorporated herein by reference.

### FIELD

The embodiments discussed herein are related to a wireless communication system, a method for wireless communication, a transmitter, and a method for controlling a transmitter.

### BACKGROUND

There has been known a wireless communication system including first and second transmitting antennas and first and second receiving antennas (see, for example, Patent Literatures 1-4 and Non-Patent Literature 1). For example, the wireless communication system illustrated in accompanying drawing FIG. 1 transmits a first signal S1 from a first transmitting antenna T11 to a first receiving antenna R11 and also transmits a second signal S2 from a first transmitting antenna T21 to a second receiving antenna R21.

The signal transmitted from the second transmitting antenna T21 is also received by the first receiving antenna R11. For example, the wireless communication system is assumed to have three propagation paths to transmit signals between the second transmitting antenna T21 and the first receiving antenna R11. In this case, signal elements included in the signal transmitted from first transmitting antenna T21 has the relationship expressed by Expression 1 with signal elements received by the first receiving antenna R11. For example, a signal element has a time length corresponding to a modulation symbol.

$$( \begin{matrix}{ρ}_{0} \\ {ρ}_{1} \\ {ρ}_{2}\end{matrix} ) = ( \begin{matrix}{a}_{0} & {a}_{1} & {a}_{2} & 0 & 0 \\ 0 & {a}_{0} & {a}_{1} & {a}_{2} & 0 \\ 0 & 0 & {a}_{0} & {a}_{1} & {a}_{2}\end{matrix} ) ( \begin{matrix}{τ}_{0} \\ {τ}_{1} \\ {τ}_{2} \\ {τ}_{3} \\ {τ}_{4}\end{matrix} ) \qquad [ Expression 1 ]$$

The elements a₀, . . . , a₂ represent a propagation channel C11 between the second transmitting antenna T21 and the first receiving antenna R11; the elements τ₀, . . . , τ₄ represent signal elements included in the signal transmitted from the second transmitting antenna T21; and the elements ρ₀, . . . , ρ₂ represent signal elements included in a signal received by the first receiving antenna R11. The first matrix on the right side of Expression 1 is a Toeplitz matrix.

The wireless communication system regards a power of a solution α for an equations of Expression 2 concerning an unknown variable θ as a weight, and transmits a second signal obtained by multiplying the weight and a signal element τ₀ from the second transmitting antenna T21 to the second receiving antenna R21. Accordingly, signal elements ρ₀, . . . , ρ₂ included in a signal received by the first receiving antenna R11 are represented by Expression 3. Since Expression 2 is satisfied, each of the signal elements ρ₀, . . . , ρ₂ included in a signal received by the first receiving antenna R11 comes to be zero. Here, a matrix having elements of powers of a having different exponents are referred to as a Vandermonde matrix.

$$\begin{matrix}{a}_{0} + {a}_{1} θ + {a}_{2} {θ}^{2} = 0 & [ Expression 2 ] \\ ( \begin{matrix}{ρ}_{0} \\ {ρ}_{1} \\ {ρ}_{2}\end{matrix} ) = ( \begin{matrix}{a}_{0} & {a}_{1} & {a}_{2} & 0 & 0 \\ 0 & {a}_{0} & {a}_{1} & {a}_{2} & 0 \\ 0 & 0 & {a}_{0} & {a}_{1} & {a}_{2}\end{matrix} ) ( \begin{matrix}{α}^{0} {τ}_{0} \\ {α}^{1} {τ}_{0} \\ {α}^{2} {τ}_{0} \\ {α}^{3} {τ}_{0} \\ {α}^{4} {τ}_{0}\end{matrix} ) = ( \begin{matrix}0 \\ 0 \\ 0\end{matrix} ) & [ Expression 3 ]\end{matrix}$$

The above manner inhibits a signal transmitted from the second transmitting antenna T21 from interfering with a signal that the first receiving antenna R11 receives from the first transmitting antenna T11. This scheme is, for example, called a Vandermonde-Subspace Frequency Division Multiplexing (VFDM) scheme.

### PRIOR ART REFERENCE

### Patent Literature

[Patent Literature 1] Japanese National Publication of International Patent Application No. 2012-510187
[Patent Literature 2] Japanese National Publication of International Patent Application No. 2008-503150
[Patent Literature 3] Japanese National Publication of International Patent Application No. 2010-515403
[Patent Literature 4] Japanese National Publication of International Patent Application No. 2007-527680

### Non-Patent Literature

[Non-Patent Literature 1] L. S. Cardoso et al., “Vandermonde-Subspace Frequency Division Multiplexing Receiver Analysis”, 2010 IEEE 21st International Symposium on Personal Indoor and Mobile Radio Communications (PIMRC), September, 2010, pp. 293-298

### SUMMARY

The above disclosures are silent about the method of determining a weight for cases where a second signal S2 is to be transmitted from multiple transmitting antennas. For the above, in transmitting the second signal S2 from multiple transmitting antennas, the quality of the first signal S1 that the first receiving antenna R11 receives, that is, the quality of the receiving signal, is sometimes degraded.

According to an aspect of the embodiments, a wireless communication system includes: a plurality of transmitting antennas; one or more receiving antennas; and a controller. The controller controls, based on a weight matrix, a weight on a signal to be transmitted from the plurality of transmitting antennas, the weight matrix coming to be a null matrix when being multiplied by a block matrix, the block matrix having, as blocks, a plurality of matrices obtained by selecting elements corresponding to a number of the plurality of transmitting antennas from a channel matrix. The channel matrix represents a plurality of propagation channels between the plurality of the transmitting antennas and the one or more receiving antennas. A block matrix may be referred to as a partitioned matrix.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of communication in a wireless communication system;

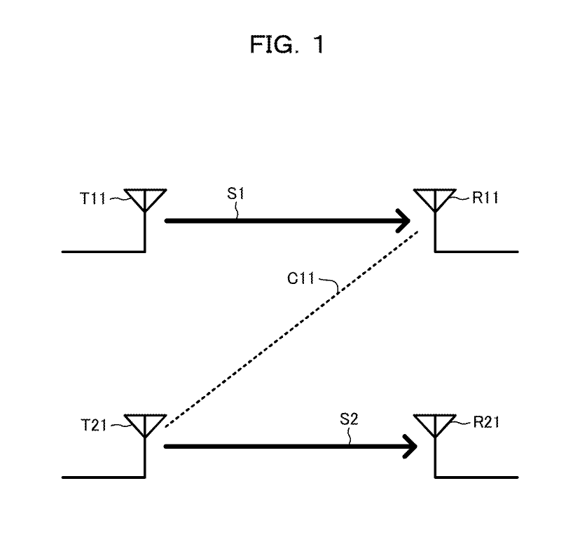

FIG. 2 is a diagram illustrating another example of communication in a wireless communication system;

FIG. 3 is a block diagram schematically illustrating an example of the configuration of a wireless communication system according to a first embodiment;

FIG. 4 is a block diagram schematically illustrating an example of the configuration of a second transmitter of FIG. 3;

FIG. 5 is a block diagram schematically illustrating an example of the configuration of a second receiver of FIG. 3;

FIG. 6 is a block diagram schematically illustrating an example of the configuration of a transmission weight calculator of FIG. 4;

FIG. 7 is a block diagram schematically illustrating an example of the configuration of a Jacobian matrix calculator of FIG. 6;

FIG. 8 is a block diagram schematically illustrating an example of the configuration of a wireless communication system according to a modification to the first embodiment;

FIG. 9 is a block diagram schematically illustrating another example of the configuration of a wireless communication system according to a modification to the first embodiment; and

FIG. 10 is a block diagram schematically illustrating an example of the configuration of a second transmitter according to a second embodiment.

### DESCRIPTION OF EMBODIMENTS

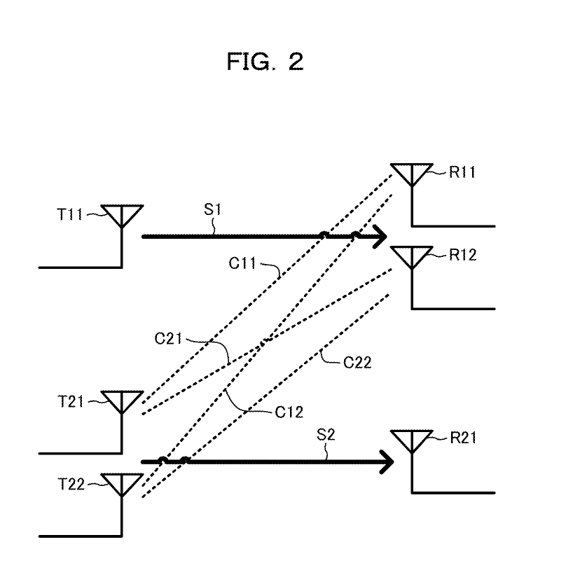

A wireless communication system sometimes transmits a second signal from multiple transmitting antennas except for a transmitting signal that transmits a first signal. It is assumed that the wireless communication system adopts VFDM scheme. For example, as illustrated in FIG. 2, the wireless communication system transmits a first signal S1 from a third transmitting antenna T11 to a first receiving antenna R11 and a second receiving antenna R12, and also transmits a second signal S2 from the first transmitting antenna T21 and a second transmitting antenna T22 to the third receiving antenna R21.

Furthermore, the wireless communication system is assumed to have three propagation paths to transmit a signal between the first transmitting antenna T21 and each of the first receiving antenna R11 and the second receiving antenna R12 and three propagation paths to transmit signal between the second transmitting antenna T22 and each of the first receiving antenna R11 and the second receiving antenna R12. With this configuration, the first embodiment assumes that the first transmitting antenna T21 and the second transmitting antenna T22 transmit the same signal elements τ₀, . . . , τ₄. Signal elements ρ₀₀, . . . , ρ₀₂ included in a signal received by the first receiving antenna R11 and signal elements ρ₁₀, . . . , ρ₁₂ included in a signal received by the second receiving antenna R12 are represented by Expression 4.

$$( \begin{matrix}{ρ}_{00} \\ {ρ}_{01} \\ {ρ}_{02} \\ {ρ}_{10} \\ {ρ}_{11} \\ {ρ}_{12}\end{matrix} ) = ( \begin{matrix}{a}_{0} & {a}_{1} & {a}_{2} & 0 & 0 & {b}_{0} & {b}_{1} & {b}_{2} & 0 & 0 \\ 0 & {a}_{0} & {a}_{1} & {a}_{2} & 0 & 0 & {b}_{0} & {b}_{1} & {b}_{2} & 0 \\ 0 & 0 & {a}_{0} & {a}_{1} & {a}_{2} & 0 & 0 & {b}_{0} & {b}_{1} & {b}_{2} \\ {c}_{0} & {c}_{1} & {c}_{2} & 0 & 0 & {d}_{0} & {d}_{1} & {d}_{2} & 0 & 0 \\ 0 & {c}_{0} & {c}_{1} & {c}_{2} & 0 & 0 & {d}_{0} & {d}_{1} & {d}_{2} & 0 \\ 0 & 0 & {c}_{0} & {c}_{1} & {c}_{2} & 0 & 0 & {d}_{0} & {d}_{1} & {d}_{2}\end{matrix} ) ( \begin{matrix}{τ}_{0} \\ {τ}_{1} \\ {τ}_{2} \\ {τ}_{3} \\ {τ}_{4} \\ {τ}_{0} \\ {τ}_{1} \\ {τ}_{2} \\ {τ}_{3} \\ {τ}_{4}\end{matrix} ) \qquad [ Expression 4 ]$$

The elements a₀, . . . , a₂ represent respective propagation channels for the three propagation paths between the first transmitting antenna T21 and the first receiving antenna R11; the elements b₀, . . . , b₂ represent respective propagation channels for the three propagation paths between the second transmitting antenna T22 and the first receiving antenna R11; the elements c₀, . . . , c₂ represent respective propagation channels for the three propagation paths between the first transmitting antenna T21 and the second receiving antenna R12; and the elements d₀, . . . , d₂ represent respective propagation channels for the three propagation paths between the second transmitting antenna T22 and the second receiving antenna R12.

For example, it is assumed that, using powers of a solution α to equations for an unknown variable θ represented by Expressions 5 and 6 and powers of a solution γ to equations for an unknown variable ω represented by Expressions 5 and 6 as weights, a second signal obtained by multiplying a signal element τ₀ by the weight is transmitted.

a₀+a₁θ+a₂θ²+b₀+b₁ω+b₂ω²=0 [Expression 5]

c₀+c₁θ+c₂θ²+d₀+d₁ω+d₂ω²=0 [Expression 6]

However, as understood by Expression 7, all the signal elements ρ₀₀, . . . , ρ₁₂ included in signals received by the first receiving antenna R11 and second receiving antenna R12 are not made to be zero. The elements ε₀₁, . . . , ε₁₂ represent values except for zero.

$$[ Expression 7 ]$$

$$( \begin{matrix}{ρ}_{00} \\ {ρ}_{01} \\ {ρ}_{02} \\ {ρ}_{10} \\ {ρ}_{11} \\ {ρ}_{12}\end{matrix} ) = ( \begin{matrix}{a}_{0} & {a}_{1} & {a}_{2} & 0 & 0 & {b}_{0} & {b}_{1} & {b}_{2} & 0 & 0 \\ 0 & {a}_{0} & {a}_{1} & {a}_{2} & 0 & 0 & {b}_{0} & {b}_{1} & {b}_{2} & 0 \\ 0 & 0 & {a}_{0} & {a}_{1} & {a}_{2} & 0 & 0 & {b}_{0} & {b}_{1} & {b}_{2} \\ {c}_{0} & {c}_{1} & {c}_{2} & 0 & 0 & {d}_{0} & {d}_{1} & {d}_{2} & 0 & 0 \\ 0 & {c}_{0} & {c}_{1} & {c}_{2} & 0 & 0 & {d}_{0} & {d}_{1} & {d}_{2} & 0 \\ 0 & 0 & {c}_{0} & {c}_{1} & {c}_{2} & 0 & 0 & {d}_{0} & {d}_{1} & {d}_{2}\end{matrix} ) ( \begin{matrix}{α}^{0} {τ}_{0} \\ {α}^{1} {τ}_{0} \\ {α}^{2} {τ}_{0} \\ {α}^{3} {τ}_{0} \\ {α}^{4} {τ}_{0} \\ {γ}^{0} {τ}_{0} \\ {γ}^{1} {τ}_{0} \\ {γ}^{2} {τ}_{0} \\ {γ}^{3} {τ}_{0} \\ {γ}^{4} {τ}_{0}\end{matrix} ) = ( \begin{matrix}0 \\ {ɛ}_{01} \\ {ɛ}_{02} \\ 0 \\ {ɛ}_{11} \\ {ɛ}_{12}\end{matrix} )$$

Accordingly, in transmitting the second signal S2 from multiple transmitting antennas T21 and T22, the quality of the first signal S1 received by the first receiving antenna R11 and the second receiving antenna R12 (in other words, the quality of the received signal) is sometime degraded.

Hereinafter, embodiments of the present invention will now be described by referring to the accompanying drawings. However, the following embodiments are merely exemplary, and modification and application of technique that are not clarified in the description below is not excluded. Like reference numbers in the all the drawings referred in the following embodiments designate the same or the substantially same parts and elements unless changes and modifications are specified.

### First Embodiment

### Configuration

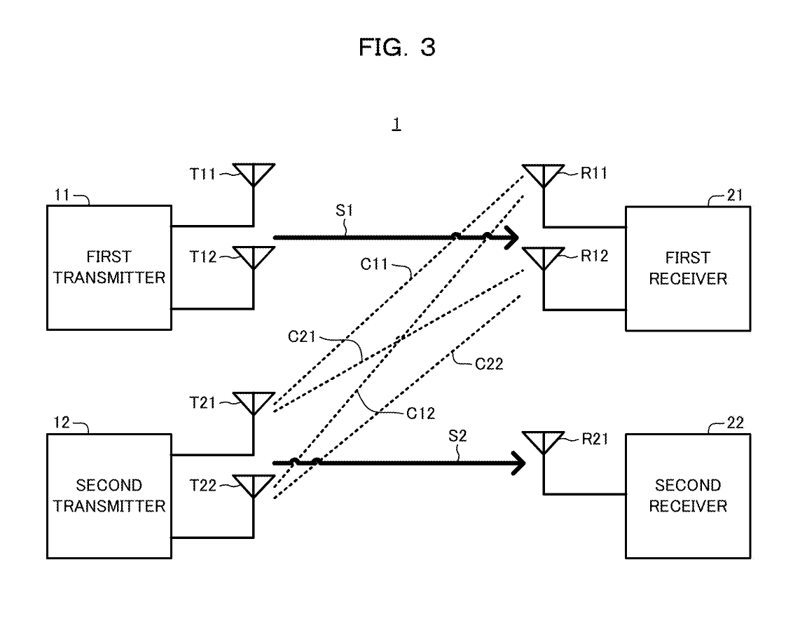

As illustrated in FIG. 3, an example of a wireless communication system 1 of the first embodiment includes a first transmitter 11, a first receiver 21, a second transmitter 12, and a second receiver 22.

The first transmitter 11 includes two transmitting antennas T11 and T12; the first receiver 21 includes two receiving antennas R11 and R12; the second transmitter 12 includes two transmitting antennas T21 and T22; and the second receiver 22 includes a single receiving antenna R21.

Alternatively, the first transmitter 11 may include three or more transmitting antennas; the first receiver 21 may include one, three or more receiving antennas; the second transmitter 12 may include three or more transmitting antennas; and the second receiver 22 may include two or more receiving antennas.

The first transmitter 11 transmits a first signal S1 through the two transmitting antennas T11 and T12 in a first communication scheme. Here, an example of the first communication scheme is the Long Term Evolution (LTE) scheme. Alternatively, the first communication scheme may be different from the LTE scheme and may be, for example, LTE-Advanced or Worldwide Interoperability for Microwave Access (WiMAX).

Further alternatively, the first communication scheme may be the Orthogonal Frequency-Division Multiplexing (OFDM) scheme or a communication scheme using a Cyclic Prefix.

The first receiver 21 receives the first signal S1 transmitted from the first transmitter 11 via the two receiving antennas R11 and R12 in the first communication scheme. In the first embodiment, the first transmitter 11 and the second transmitter 12 communicate with each other in the Multiple Input and Multiple Output (MIMO) scheme.

In the first embodiment, it can be said that the first transmitter 11 and the first receiver 21 constitute a first wireless communication system.

The second transmitter 12 transmits a second signal S2 via the two transmitting antennas T21 and T22 in a second communication scheme. In this embodiment, the second signal S2 has the same frequency as the first signal S1 and is transmitted in parallel with (e.g., simultaneously with) the first signal S1. In this embodiment, the second communication scheme is different from the first communication scheme.

The second communication scheme of this embodiment calculates a transmission weight and transmits a transmission signal obtained by multiplying the calculated weight. The second communication scheme will be detailed below.

The second receiver 22 receives the second signal S2 transmitted from the second transmitter 12 via the single receiving antenna R21 in the second communication scheme.

In this embodiment, it can be said that the second transmitter 12 and the second receiver 22 constitute a second wireless communication system.

In this embodiment, the second transmitter 12 and the first receiver 21 are immovable. For example, the second transmitter 12 and the first receiver 21 may be base stations.

In this case, the propagation channels between the transmission antennas T21 and T22 included in the second transmitter 12 and the receiving antennas R11 and R12 included in the first receiver 21 less fluctuate as time passes. On the basis of this characteristic, the first receiver 21 of the first embodiment previously measures the propagation channels between the transmission antennas T21 and T22 included in the second transmitter 12 and the receiving antennas R11 and R12 included in the first receiver 21.

In the first embodiment, the propagation channels are the propagation channels from the transmission antennas T21 and T22 included in the second transmitter 12 to the receiving antennas R11 and R12 included in the first receiver 21. The first receiver 21 notifies information representing the measured propagation channels to the second transmitter 12.

The second transmitter 12 calculates transmission weights based on the propagation channels represented by the notified information and retains the calculated transmission weights. The calculation of a transmission weight, which will be detailed below, is an example of determination of a transmission weight.

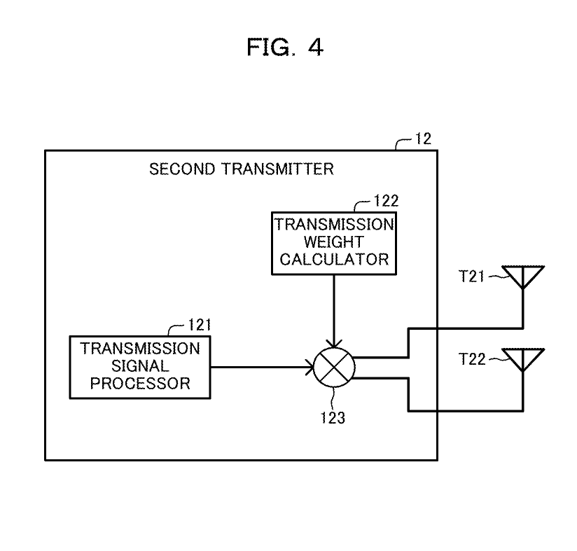

For example, as illustrated in FIG. 4, the second transmitter 12 includes a transmission signal processor 121, a transmission weight calculator 122, and a multiplier 123.

The transmission signal processor 121 generates a transmission signal.

The transmission weight calculator 122 calculates transmission weights on the basis of the propagation channels represented by the information notified from the first receiver 21. The transmission weight calculator 122 is an example of a controller that controls a transmission weight on a signal to be transmitted from the multiple transmission antennas T21 and T22 included in the second transmitter 12.

The multiplier 123 multiplies a transmission signal generated by the transmission signal processor 121 and the calculated transmission weights and transmits the transmission signal multiplied by the transmission weights through the two transmission antennas T21 and T22.

At least part of the function of the second transmitter 12 may be accomplished by a Large Scale Integration (LSI) or a Programmable Logic Device (PLD). Furthermore, at least part of the second transmitter 12 may be achieved by a memory device that stores therein a program in advance and a processor that executes the program stored in the memory device.

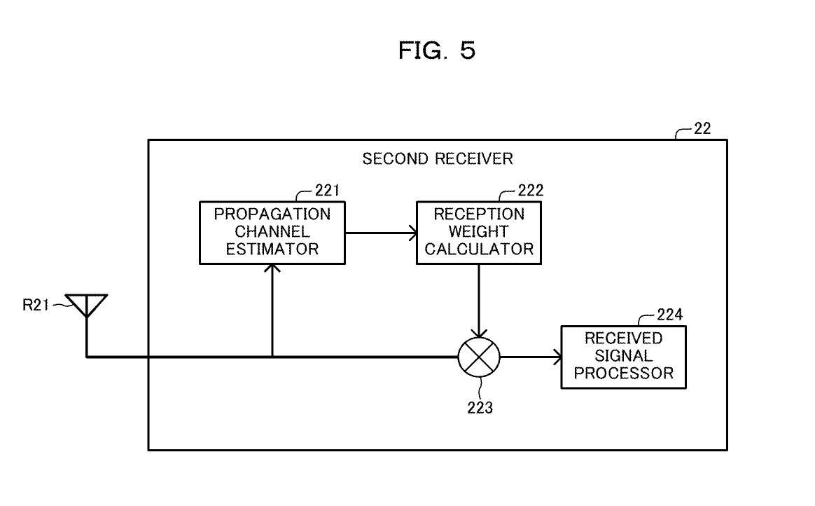

For example, as illustrated in FIG. 5, the second receiver 22 includes a propagation channel estimator 221, a reception weight calculator 222, a multiplier 223, and a received signal processor 224.

The propagation channel estimator 221 estimates weighed propagation channels between the transmission antennas T21 and T22 included in the second transmitter 12 and the receiving antenna R21. The weighed propagation channels are represented by the product HW of the propagation channels H between the transmission antennas T21 and T22 included in the second transmitter 12 and the receiving antenna R21 and the transmission weights W.

In this embodiment, the propagation channel estimator 221 estimates, if the receiving antenna R21 receives a signal of a known signal multiplied by the transmission weights from the second transmitter 12, the weighed propagation channel on the basis of the received signal and the known signal. The known signal of this embodiment is a signal previously known to both the second transmitter 12 and the second receiver 22.

The reception weight calculator 222 calculates reception weights W_{R} based on the weighed propagation channels HW estimated by the propagation channel estimator 221 and Expression 8. In Expression 8, the symbol Ω^{H} represents a complex conjugate transported matrix of a matrix Ω; the symbol I represents an identity matrix; and the symbol σ² represents noise power.

W_{R}=((HW)(HW)^{H}+σ²I)HW [Expression 8]

Namely, the reception weight calculator 222 of this embodiment calculates reception weights W_{R} in accordance with the rule of Minimum Mean Squared Error (MMSE).

The multiplier 223 multiplies the reception weights calculated by the reception weight calculator 222 and the signal received by the receiving antenna R21. Thereby, the signal received by the receiving signal R21 is demodulated.

The received signal processor 224 processes the signal multiplied by the reception weights by the multiplier 223. For example, the received signal processor 224 may carry out error correction on the signal multiplied by the reception weights.

At least part of the function of the second receiver 22 may be accomplished by an LSI or a PLD. Furthermore, at least part of the second receiver 22 may be achieved by a memory device that stores therein a program in advance and a processor that executes the program stored in the memory device.

Hereinafter, the calculation of a transmission weight by the transmission weight calculator 122 will now be detailed.

For example, likewise the above case, the following description assumes that each of the two transmission antennas T21 and T22 included in the second transmitter 12 has three propagation paths to propagate signals to each of the two receiving antennas R11 and R12 included in the first receiver 21.

The description further assumes that the transmission antennas T21 and T22 transmit signal elements τ₀ multiplied by each of the transmission weights w₀₀, . . . , w₁₄ and the transmission signals from the two transmission antennas T21 and T22 each includes five signal elements. In this case, the signal elements ρ₀₀, . . . , ρ₀₂ included in a signal received by the receiving antenna R11 and the signal elements ρ₁₀, . . . , ρ₁₂ included in a signal received by the receiving antenna R12 are represented by Expression 9.

$$[ Expression 9 ]$$

$$( \begin{matrix}{ρ}_{00} \\ {ρ}_{01} \\ {ρ}_{02} \\ {ρ}_{10} \\ {ρ}_{11} \\ {ρ}_{12}\end{matrix} ) = ( \begin{matrix}{a}_{0} & {a}_{1} & {a}_{2} & 0 & 0 & {b}_{0} & {b}_{1} & {b}_{2} & 0 & 0 \\ 0 & {a}_{0} & {a}_{1} & {a}_{2} & 0 & 0 & {b}_{0} & {b}_{1} & {b}_{2} & 0 \\ 0 & 0 & {a}_{0} & {a}_{1} & {a}_{2} & 0 & 0 & {b}_{0} & {b}_{1} & {b}_{2} \\ {c}_{0} & {c}_{1} & {c}_{2} & 0 & 0 & {d}_{0} & {d}_{1} & {d}_{2} & 0 & 0 \\ 0 & {c}_{0} & {c}_{1} & {c}_{2} & 0 & 0 & {d}_{0} & {d}_{1} & {d}_{2} & 0 \\ 0 & 0 & {c}_{0} & {c}_{1} & {c}_{2} & 0 & 0 & {d}_{0} & {d}_{1} & {d}_{2}\end{matrix} ) ( \begin{matrix}{w}_{00} {τ}_{0} \\ {w}_{01} {τ}_{0} \\ {w}_{02} {τ}_{0} \\ {w}_{03} {τ}_{0} \\ {w}_{04} {τ}_{0} \\ {w}_{10} {τ}_{0} \\ {w}_{11} {τ}_{0} \\ {w}_{12} {τ}_{0} \\ {w}_{13} {τ}_{0} \\ {w}_{14} {τ}_{0}\end{matrix} )$$

The elements a₀, . . . , a₂ represent propagation channels C11 for the three propagation paths between the transmitting antenna T21 and the receiving antenna R11; the elements b₀, . . . , b₂ represent propagation channels C12 for the three propagation paths between the transmitting antenna T22 and the receiving antenna R11; the elements c₀, . . . , c₂ represent propagation channels C21 for the three propagation paths between the transmitting antenna T21 and the receiving antenna R12; and the elements d₀, . . . , d₂ represent propagation channels C22 for the three propagation paths between the transmitting antenna T22 and the receiving antenna R12.

The symbols w₀₀, . . . , w₀₄ represent the transmission weights that are to be subsequently multiplied on the signal element τ₀ transmitted through the transmitting antenna T21 each time the time length of the signal element passes. Likewise, the symbols w₁₀, . . . , w₁₄ represent the transmission weights that are to be subsequently multiplied on the signal element τ₀ transmitted through the transmitting antenna T22 each time the time length of the signal element passes.

In this embodiment, the first matrix of the right side in Expression 9 can be referred to as a channel matrix.

Interchanging the elements in the second row with the elements in the fourth row of the matrix of the left side and the first matrix of the right side in Expression 9 converts Expression 9 into Expression 10.

$$[ Expression 10 ]$$

$$( \begin{matrix}{ρ}_{00} \\ {ρ}_{10} \\ {ρ}_{02} \\ {ρ}_{01} \\ {ρ}_{11} \\ {ρ}_{12}\end{matrix} ) = ( \begin{matrix}{a}_{0} & {a}_{1} & {a}_{2} & 0 & 0 & {b}_{0} & {b}_{1} & {b}_{2} & 0 & 0 \\ {c}_{0} & {c}_{1} & {c}_{2} & 0 & 0 & {d}_{0} & {d}_{1} & {d}_{2} & 0 & 0 \\ 0 & 0 & {a}_{0} & {a}_{1} & {a}_{2} & 0 & 0 & {b}_{0} & {b}_{1} & {b}_{2} \\ 0 & {a}_{0} & {a}_{1} & {a}_{2} & 0 & 0 & {b}_{0} & {b}_{1} & {b}_{2} & 0 \\ 0 & {c}_{0} & {c}_{1} & {c}_{2} & 0 & 0 & {d}_{0} & {d}_{1} & {d}_{2} & 0 \\ 0 & 0 & {c}_{0} & {c}_{1} & {c}_{2} & 0 & 0 & {d}_{0} & {d}_{1} & {d}_{2}\end{matrix} ) ( \begin{matrix}{w}_{00} {τ}_{0} \\ {w}_{01} {τ}_{0} \\ {w}_{02} {τ}_{0} \\ {w}_{03} {τ}_{0} \\ {w}_{04} {τ}_{0} \\ {w}_{10} {τ}_{0} \\ {w}_{11} {τ}_{0} \\ {w}_{12} {τ}_{0} \\ {w}_{13} {τ}_{0} \\ {w}_{14} {τ}_{0}\end{matrix} )$$

Interchanging the elements in the third row with the elements in the fourth row of the matrix of the left side and the first matrix of the right side in Expression 10 and then interchanging the elements in the fourth row with the elements in the fifth row in the same matrices in Expression 10 convert the Expression 10 into Expression 11.

$$[ Expression 11 ]$$

$$( \begin{matrix}{ρ}_{00} \\ {ρ}_{10} \\ {ρ}_{01} \\ {ρ}_{11} \\ {ρ}_{02} \\ {ρ}_{12}\end{matrix} ) = ( \begin{matrix}{a}_{0} & {a}_{1} & {a}_{2} & 0 & 0 & {b}_{0} & {b}_{1} & {b}_{2} & 0 & 0 \\ {c}_{0} & {c}_{1} & {c}_{2} & 0 & 0 & {d}_{0} & {d}_{1} & {d}_{2} & 0 & 0 \\ 0 & {a}_{0} & {a}_{1} & {a}_{2} & 0 & 0 & {b}_{0} & {b}_{1} & {b}_{2} & 0 \\ 0 & {c}_{0} & {c}_{1} & {c}_{2} & 0 & 0 & {d}_{0} & {d}_{1} & {d}_{2} & 0 \\ 0 & 0 & {a}_{0} & {a}_{1} & {a}_{2} & 0 & 0 & {b}_{0} & {b}_{1} & {b}_{2} \\ 0 & 0 & {c}_{0} & {c}_{1} & {c}_{2} & 0 & 0 & {d}_{0} & {d}_{1} & {d}_{2}\end{matrix} ) ( \begin{matrix}{w}_{00} {τ}_{0} \\ {w}_{01} {τ}_{0} \\ {w}_{02} {τ}_{0} \\ {w}_{03} {τ}_{0} \\ {w}_{04} {τ}_{0} \\ {w}_{10} {τ}_{0} \\ {w}_{11} {τ}_{0} \\ {w}_{12} {τ}_{0} \\ {w}_{13} {τ}_{0} \\ {w}_{14} {τ}_{0}\end{matrix} )$$

The matrix of the right side in Expression 9 can be regarded as a block matrix that sequentially arranges two blocks of matrices each chronologically arranging signal elements received by one of the two receiving antennas R11 and R12 as time passes. In contrast, the matrix of the right side in Expression 11 can be regarded as a block matrix that sequentially arranges blocks each chronologically arranging signal elements received at a certain timing by the two receiving antennas R11 and R12 as time passes.

Interchanging the elements in the second column with the sixth column in the first matrix of the right side and also interchanging the elements in the second row with the sixth row in the second matrix of the right side convert Expression 11 into Expression 12.

$$[ Expression 12 ]$$

$$( \begin{matrix}{ρ}_{00} \\ {ρ}_{10} \\ {ρ}_{01} \\ {ρ}_{11} \\ {ρ}_{02} \\ {ρ}_{12}\end{matrix} ) = ( \begin{matrix}{a}_{0} & {b}_{0} & {a}_{2} & 0 & 0 & {a}_{1} & {b}_{1} & {b}_{2} & 0 & 0 \\ {c}_{0} & {d}_{0} & {c}_{2} & 0 & 0 & {c}_{1} & {d}_{1} & {d}_{2} & 0 & 0 \\ 0 & 0 & {a}_{1} & {a}_{2} & 0 & {a}_{0} & {b}_{0} & {b}_{1} & {b}_{2} & 0 \\ 0 & 0 & {c}_{1} & {c}_{2} & 0 & {c}_{0} & {d}_{0} & {d}_{1} & {d}_{2} & 0 \\ 0 & 0 & {a}_{0} & {a}_{1} & {a}_{2} & 0 & 0 & {b}_{0} & {b}_{1} & {b}_{2} \\ 0 & 0 & {c}_{0} & {c}_{1} & {c}_{2} & 0 & 0 & {d}_{0} & {d}_{1} & {d}_{2}\end{matrix} ) ( \begin{matrix}{w}_{00} {τ}_{0} \\ {w}_{10} {τ}_{0} \\ {w}_{02} {τ}_{0} \\ {w}_{03} {τ}_{0} \\ {w}_{04} {τ}_{0} \\ {w}_{01} {τ}_{0} \\ {w}_{11} {τ}_{0} \\ {w}_{12} {τ}_{0} \\ {w}_{13} {τ}_{0} \\ {w}_{14} {τ}_{0}\end{matrix} )$$

Furthermore, interchanging between the elements of (A1)-(A5) in the first matrix of the right side of Expression 12 and also interchanging between the elements of (B1)-(B5) of the second matrix of the right side of Expression 12 convert Expression 12 into Expression 13.

(A1) interchanging the elements in the third column with the elements in the sixth column;
(B1) interchanging the elements in the third row with the elements in the sixth row;
(A2) interchanging the elements in the fourth column with the elements in the seventh column;
(B2) interchanging the elements in the fourth row with the elements in the seventh row;
(A3) interchanging the elements in the fifth column with the elements in the sixth column;
(B3) interchanging the elements in the fifth row with the elements in the sixth row;
(A4) interchanging the elements in the sixth column with the elements in the eighth column;
(B4) interchanging the elements in the sixth row with the elements in the eighth row;
(A5) interchanging the elements in the eighth column with the elements in the ninth column; and
(B5) interchanging the elements in the eighth row with the elements in the ninth row.

$$[ Expression 13 ]$$

$$( \begin{matrix}{ρ}_{00} \\ {ρ}_{10} \\ {ρ}_{01} \\ {ρ}_{11} \\ {ρ}_{02} \\ {ρ}_{12}\end{matrix} ) = ( \begin{matrix}{a}_{0} & {b}_{0} & {a}_{1} & {b}_{1} & {a}_{2} & {b}_{2} & 0 & 0 & 0 & 0 \\ {c}_{0} & {d}_{0} & {c}_{1} & {d}_{1} & {c}_{2} & {d}_{2} & 0 & 0 & 0 & 0 \\ 0 & 0 & {a}_{0} & {b}_{0} & {a}_{1} & {b}_{1} & {a}_{2} & {b}_{2} & 0 & 0 \\ 0 & 0 & {c}_{0} & {d}_{0} & {c}_{1} & {d}_{1} & {c}_{2} & {d}_{2} & 0 & 0 \\ 0 & 0 & 0 & 0 & {a}_{0} & {b}_{0} & {a}_{1} & {b}_{1} & {a}_{2} & {b}_{2} \\ 0 & 0 & 0 & 0 & {c}_{0} & {d}_{0} & {c}_{1} & {d}_{1} & {c}_{2} & {d}_{2}\end{matrix} ) ( \begin{matrix}{w}_{00} {τ}_{0} \\ {w}_{10} {τ}_{0} \\ {w}_{01} {τ}_{0} \\ {w}_{11} {τ}_{0} \\ {w}_{02} {τ}_{0} \\ {w}_{12} {τ}_{0} \\ {w}_{03} {τ}_{0} \\ {w}_{13} {τ}_{0} \\ {w}_{04} {τ}_{0} \\ {w}_{14} {τ}_{0}\end{matrix} )$$

The second matrix of the right side in Expression 11 can be regarded as a block matrix that sequentially arranges two blocks of matrices each chronologically arranging signal elements received by one of the two transmitting antennas T21 and T22 as time passes. In contrast, the matrix of the right side in Expression 13 can be regarded as a block matrix that sequentially arranges blocks each chronologically arranging signal elements received at a certain timing by the two transmitting antennas T21 and T22 as time passes.

Expressing the three 2×2 blocks having elements not being zero in the first matrix of the right side of Expression 13 in square matrices A₀, . . . , A₂ of Expressions 14-16 converts the first matrix H in the right side of Expression 13 into Expression 17. The matrix H represented by Expression 17 can be regarded as a Toeplitz matrix in a block unit or a block Toeplitz matrix. Furthermore, the matrix H of Expression 17 can be regarded as a block matrix having, as the blocks, multiple matrices A₀, . . . , A₂ obtained by selecting elements corresponding to the number of transmitting antennas included in the second transmitter 12 from the first matrix of the right side of Expression 9.

$$\begin{matrix}{A}_{0} = ( \begin{matrix}{a}_{0} & {b}_{0} \\ {c}_{0} & {d}_{0}\end{matrix} ) & [ Expression 14 ] \\ {A}_{1} = ( \begin{matrix}{a}_{1} & {b}_{1} \\ {c}_{1} & {d}_{1}\end{matrix} ) & [ Expression 15 ] \\ {A}_{2} = ( \begin{matrix}{a}_{2} & {b}_{2} \\ {c}_{2} & {d}_{2}\end{matrix} ) & [ Expression 16 ] \\ \begin{matrix}H = ( \begin{matrix}{a}_{0} & {b}_{0} & {a}_{1} & {b}_{1} & {a}_{2} & {b}_{2} & 0 & 0 & 0 & 0 \\ {c}_{0} & {d}_{0} & {c}_{1} & {d}_{1} & {c}_{2} & {d}_{2} & 0 & 0 & 0 & 0 \\ 0 & 0 & {a}_{0} & {b}_{0} & {a}_{1} & {b}_{1} & {a}_{2} & {b}_{2} & 0 & 0 \\ 0 & 0 & {c}_{0} & {d}_{0} & {c}_{1} & {d}_{1} & {c}_{2} & {d}_{2} & 0 & 0 \\ 0 & 0 & 0 & 0 & {a}_{0} & {b}_{0} & {a}_{1} & {b}_{1} & {a}_{2} & {b}_{2} \\ 0 & 0 & 0 & 0 & {c}_{0} & {d}_{0} & {c}_{1} & {d}_{1} & {c}_{2} & {d}_{2}\end{matrix} ) \\ = ( \begin{matrix}{A}_{0} & {A}_{1} & {A}_{2} & 0 & 0 \\ 0 & {A}_{0} & {A}_{1} & {A}_{2} & 0 \\ 0 & 0 & {A}_{0} & {A}_{1} & {A}_{2}\end{matrix} )\end{matrix} & [ Expression 17 ]\end{matrix}$$

Accordingly, as denoted in Expression 19, the product of the matrix H and a block matrix having blocks of multiple powers having different exponents of solutions S₁ and S₂ for the equation represented by Expression 18 for the 2×2 square matrix X having an unknown variable as an element is a null matrix. In other words, the matrix H is perpendicular to a block matrix having blocks of multiple powers having different exponents of solutions S₁ and S₂ for the equation represented by Expression 18 for the 2×2 square matrix X whose elements are unknown variables.

$$\begin{matrix}{A}_{0} + {A}_{1} X + {A}_{2} {X}^{2} = 0 & [ Expression 18 ] \\ ( \begin{matrix}{A}_{0} & {A}_{1} & {A}_{2} & 0 & 0 \\ 0 & {A}_{0} & {A}_{1} & {A}_{2} & 0 \\ 0 & 0 & {A}_{0} & {A}_{1} & {A}_{2}\end{matrix} ) ( \begin{matrix}{S}_{1}^{0} & {S}_{2}^{0} \\ {S}_{1}^{1} & {S}_{2}^{1} \\ {S}_{1}^{2} & {S}_{2}^{2} \\ {S}_{1}^{3} & {S}_{2}^{3} \\ {S}_{1}^{4} & {S}_{2}^{4}\end{matrix} ) = 0 & [ Expression 19 ]\end{matrix}$$

In this embodiment, the equations represented by Expression 18 can be regarded as nonlinear simultaneous equations having multiple variables; and the second matrix of the left side of Expression 19 can be regarded as a Vandermonde matrix of a block unit or a Vandermonde matrix.

In this embodiment, as denoted by Expression 20, the second matrix of the left side of Expression 19 is referred to as a weight matrix W.

$$W = ( \begin{matrix}{S}_{1}^{0} & {S}_{2}^{0} \\ {S}_{1}^{1} & {S}_{2}^{1} \\ {S}_{1}^{2} & {S}_{2}^{2} \\ {S}_{1}^{3} & {S}_{2}^{3} \\ {S}_{1}^{4} & {S}_{2}^{4}\end{matrix} ) \qquad [ Expression 20 ]$$

In this embodiment, as denoted by Expression 21, the transmission weight calculator 122 uses a certain column of the weight matrix W as the transmission weights w₀₀, . . . , w₁₄. A symbol Wₘₙ represents an element in the m-th row and the n-th column of the weight matrix W. The symbol m represents an integer among one to the number (in this example, four) of columns of the weight matrix W and the symbol n represents an integer among one to the number (in this example, ten) of rows of the weight matrix W.

$$( \begin{matrix}{w}_{00} \\ {w}_{10} \\ {w}_{01} \\ {w}_{11} \\ {w}_{02} \\ {w}_{12} \\ {w}_{03} \\ {w}_{13} \\ {w}_{04} \\ {w}_{14}\end{matrix} ) = ( \begin{matrix}{W}_{m 1} \\ {W}_{m 2} \\ {W}_{m 3} \\ {W}_{m 4} \\ {W}_{m 5} \\ {W}_{m 6} \\ {W}_{m 7} \\ {W}_{m 8} \\ {W}_{m 9} \\ {W}_{m 10}\end{matrix} ) \qquad [ Expression 21 ]$$

The above example assumes that: the second transmitter 12 includes two transmitting antennas and three transmission paths; the first receiver 21 includes two receiving antennas; the second transmitter 12 is connected to the first receiver 21 via three propagation paths; and a transmission signal includes five signal elements. Generalization of the transmission antenna number, the receiving antenna number, the propagation path number, and the signal elements number included in a transmission signal expresses the channel matrix H into Expression 22.

$$H = ( \begin{matrix}{A}_{0} & {A}_{1} & … & {A}_{N - 1} & {A}_{N} & 0 & … & 0 \\ 0 & {A}_{0} & {A}_{1} & … & {A}_{N - 1} & {A}_{N} & … & 0 \\ ⋮ & ⋮ & ⋮ & ⋮ & ⋮ & ⋮ & ⋮ & ⋮ \\ 0 & … & {A}_{0} & {A}_{1} & … & {A}_{N - 1} & {A}_{N} & 0 \\ 0 & … & 0 & {A}_{0} & {A}_{1} & … & {A}_{N - 1} & {A}_{N}\end{matrix} ) \qquad [ Expression 22 ]$$

The symbol N represents a value obtained by subtracting one from the number of propagation paths; and the symbol Aᵢ represents an N_{RX}×N_{TX} matrix of the i-th propagation path. The symbol i represents an integer among 0 through N; the symbol N_{RX} represents the number of receiving antennas included in the first receiver 21; and the symbol N_{TX} represents the number of transmitting antennas included in the second transmitter 12.

The element in the u-th row and the v-th column of the matrix Aᵢ represents a propagation channel between the u-th receiving antenna among the multiple receiving antennas included in the first receiver 21 and the v-th transmitting antenna among the multiple transmitting antennas included in the second transmitter 12. The symbol u represents an integer among one to N_{RX} and the symbol v represents an integer among one to N_{RX}.

The number of columns of the channel matrix H is the same as the product of the number N_{TX} of transmission antennas included in the second transmitter 12 and the number Z of signal elements included in a transmission signal.

As denoted in Expression 23, the weight matrix W of this case is a block matrix having blocks of powers of N_{TX}×N_{TX} square matrices S₁, . . . , S_{M} having different exponents. Since the matrices S₁, . . . , S_{M} are each an N_{TX}×N_{TX} square matrix, the S₁, . . . , S_{M} each has elements the same as the number N_{TX} of transmission antennas included in the second transmitter 12. The matrices S₁, . . . , S_{M} are solutions for the equation for an N_{TX}×N_{TX} square matrix X having an unknown variable which equation is represented by Expression 24.

$$\begin{matrix}W = ( \begin{matrix}{S}_{1}^{0} & {S}_{2}^{0} & … & {S}_{M}^{0} \\ {S}_{1}^{1} & {S}_{2}^{1} & … & {S}_{M}^{1} \\ ⋮ & ⋮ & ⋮ & ⋮ \\ {S}_{1}^{Z} & {S}_{2}^{Z} & … & {S}_{M}^{Z}\end{matrix} ) & [ Expression 23 ] \\ {\sum }_{i = 0}^{N} {A}_{i} {X}^{i} = 0 & [ Expression 24 ]\end{matrix}$$

Accordingly, the transmission weight calculator 122 calculates the weight matrix W of Expression 23 by solving the equation represented by Expression 24. Consequently, the transmission weight calculator 122 calculates the transmission weights. In this example, the solution for the equation represented by Expression 24 is obtained in Newton's method for a multi-variable function.

The product of the matrix H and the block matrix W having blocks of powers of the solutions S₁, . . . , S_{M} for the equation of Expression 24 for an N_{TX}×N_{TX} square matrix, which powers have different exponents is a null matrix as denoted in Expression 25. In other words, the matrix H is perpendicular to the block matrix W having blocks of powers of the solutions S₁, . . . , S_{M} for the equation of Expression 24 for an N_{TX}×N_{TX} square matrix, which powers have different exponents.

$$( \begin{matrix}{A}_{0} & {A}_{1} & … & {A}_{N - 1} & {A}_{N} & 0 & … & 0 \\ 0 & {A}_{0} & {A}_{1} & … & {A}_{N - 1} & {A}_{N} & … & 0 \\ ⋮ & ⋮ & ⋮ & ⋮ & ⋮ & ⋮ & ⋮ & ⋮ \\ 0 & … & {A}_{0} & {A}_{1} & … & {A}_{N - 1} & {A}_{N} & 0 \\ 0 & … & 0 & {A}_{0} & {A}_{1} & … & {A}_{N - 1} & {A}_{N}\end{matrix} ) ( \begin{matrix}{S}_{1}^{0} & {S}_{2}^{0} & … & {S}_{M}^{0} \\ {S}_{1}^{1} & {S}_{2}^{1} & … & {S}_{M}^{1} \\ ⋮ & ⋮ & ⋮ & ⋮ \\ {S}_{1}^{Z} & {S}_{2}^{Z} & … & {S}_{M}^{Z}\end{matrix} ) = 0 \qquad [ Expression 25 ]$$

Description will now be made in relation to Newton's method that the transmission weight calculator 122 adopts.

L equations for L unknown variables x₁, . . . , x_{L} are represented by Expression 26. The symbol L represents an integer of one or more.

f(x)=0 [Expression 26]

The symbol x is represented by Expression 27. The symbol Ω^{T} represents the transpose of a matrix Ω. The matrix x has a single column and therefore may be referred to as a vector x.

x=(x₁,x₂, . . . ,x_{L})^{T} [Expression 27]

The term f(x) is represented by Expression 28. The symbols f₁(x), . . . , f_{L}(x) represent L functions. The functional matrix f(x) has a single column, and therefore may be referred to as a function vector f(x). A functional matrix is a matrix having functions as the elements.

f(x)=(f₁(x),f₂(x), . . . ,f_{L}(x))^{T} [Expression 28]

In Newton's method, a solution for the equation represented by Expression 26 can be obtained by repetitiously obtaining the vector x on the basis of the Expression 29. The vector x^{(t)} represents the vector x calculated for the t-th time. The symbol t represents an integer of one or more. The vector x⁽⁰⁾ is the predetermined initial value of the vector x. In Newton's method, the vector x^{(t+1)} calculated using Expression 29 converges on a solution close to the initial value x⁽⁰⁾ as the number t of times of calculating increases.

x^{(t+1)}=x^{(t)}−J(x^{(t)})⁻¹f(x^{(t)}) [Expression 29]

The symbol J represents a Jacobian matrix. The element Jₖ₁ (x) in the k-th row and the 1-th column of a Jacobian matrix is represented by Expression 30. The symbols k and l are integers of one to L.

$${J}_{kl} ( x ) = \frac{\partial {f}_{k} ( x )}{\partial {x}_{l}} \qquad [ Expression 30 ]$$

Expressing the left side of Expression 24 in a functional matrix Y(X) converts Expression 24 into Expression 31. The relationship among the symbols x, f, and J in Expressions 26-30 and the matrices X and Y in Expression 31 will be detailed below.

$$Y ( X ) = {\sum }_{i = 0}^{N} {A}_{i} {X}^{i} = 0 \qquad [ Expression 31 ]$$

The functional matrix Y(X) includes a power of a matrix. Calculating a derivative of a power of a matrix has more difficulty than calculating a derivative of a power of a scalar variable. One of assumable schemes to calculate a derivative is to expand the power of the matrix and then analytically calculate the derivative. However, analytical calculating a derivative comes to be more difficult as increase in the exponent of the power or the size of the matrix. Considering the above, the transmission weight calculator 122 of this embodiment calculates a Jacobian matrix as will be detailed below.

In cases where the elements of R×R square matrices Γ and Ψ are the function of a variable ξ, the differential of the elements (ΓΨ)_{gh} in the g-th row and the h-th column of the product ΓΨ of the matrices Γ and Ψ for variable ξ is represented by Expression 32. Here, the symbol R represents an integer of two or more; the symbol Γ_{gr} represents an element in the g-th row and the r-th column of the matrix Γ; the symbol Ψᵣₕ represents an element in the r-th row and the h-th column of the matrix W; and the symbols r, g, and h each represents an integer of one through R.

$$\frac{\partial {( ΓΨ )}_{gh}}{\partial ξ} = \frac{\partial }{\partial ξ} ( {\sum }_{r = 1}^{R} {Γ}_{gr} {Ψ}_{rh} ) = {\sum }_{r = 1}^{R} ( \frac{\partial {Γ}_{gr}}{\partial ξ} {Ψ}_{rh} + {Γ}_{gr} \frac{\partial {Ψ}_{rh}}{\partial ξ} ) \qquad [ Expression 32 ]$$

Accordingly, the differential of the product ΓΨ of the matrices Γ and Ψ for variable ξ is represented by Expression 33. The differential of a matrix represents a matrix having the differential of each element of the original matrix.

$$\frac{\partial ( ΓΨ )}{\partial ξ} = \frac{\partial Γ}{\partial ξ} Ψ + Γ \frac{\partial Ψ}{\partial ξ} \qquad [ Expression 33 ]$$

According to Expression 33, the differential of a power of a matrix X for the variable ξ is represented by Expression 34.

$$\begin{matrix}\frac{\partial }{\partial ξ} {X}^{i} = \frac{\partial }{\partial ξ} ( {X}^{i - 1} X ) \\ = \frac{\partial {X}^{i - 1}}{\partial ξ} X + {X}^{i - 1} \frac{\partial X}{\partial ξ} \\ = \frac{\partial {X}^{i - 2}}{\partial ξ} {X}^{2} + {X}^{i - 2} \frac{\partial X}{\partial ξ} X + {X}^{i - 1} \frac{\partial X}{\partial ξ} \\ = {\sum }_{j = 1}^{i} {X}^{i - j} \frac{\partial X}{\partial ξ} {X}^{j - 1}\end{matrix} \qquad [ Expression 34 ]$$

In Expression 34, the differential of the power of the matrix X is represented by the product of the differential of the matrix X and the power of the matrix X. Furthermore, the differential of the element Xₘₙ in the m-th row and the n-th column of the matrix X for the element X_{pq} in the p-th row and the q-th column of the matrix X is represented by Expression 35. The symbols m, n p, and q are each represents an integer of one through N_{TX}.

$$\frac{\partial {X}_{mn}}{\partial {X}_{pq}} = \{ \begin{matrix}1 & ( m = p and n = q ) \\ 0 & ( m \neq p or n \neq q )\end{matrix} \} \qquad [ Expression 35 ]$$

For example, when N_{TX} is two, the differential of the matrix X represented by Expression 36 for the element X₁₁ in the first row and the first column of the matrix X is represented by Expression 37.

$$\begin{matrix}X = ( \begin{matrix}{X}_{11} & {X}_{12} \\ {X}_{21} & {X}_{22}\end{matrix} ) & [ Expression 36 ] \\ \frac{\partial X}{\partial {X}_{11}} = ( \begin{matrix}1 & 0 \\ 0 & 0\end{matrix} ) & [ Expression 37 ]\end{matrix}$$

Accordingly, the differential of the functional matrix Y(X) for the element X_{pq} in the p-th row and q-th column of the matrix X is represented by Expression 38.

$$\frac{\partial Y}{\partial {X}_{pq}} = {\sum }_{i = 0}^{N} {A}_{i} {\sum }_{j = 1}^{i} {X}^{i - j} \frac{\partial X}{\partial {X}_{pq}} {X}^{j - 1} \qquad [ Expression 38 ]$$

As denoted in Expression 35, the differential of the matrix X results in a matrix having constants of only zero and one as the elements. Consequently, according to claim 38, the differential of the functional matrix Y(X) for the elements X_{pq} in the p-th row and the q-th column of the matrix X is calculated from the product and the sum of matrices.

The relationship among the symbols x, f, and J in Expressions 26-30 and the matrices X and Y in Expressions 31, 35, and 38 is represented by Expressions 39-43.

$$\begin{matrix}{x}_{l} = {X}_{pq} & [ Expression 39 ] \\ {f}_{l} = {Y}_{pq} & [ Expression 40 ] \\ {J}_{kl} = \frac{\partial {Y}_{mn}}{\partial {X}_{pq}} & [ Expression 41 ] \\ k = ( m - 1 ) N + n & [ Expression 42 ] \\ l = ( p - 1 ) N + q & [ Expression 43 ]\end{matrix}$$

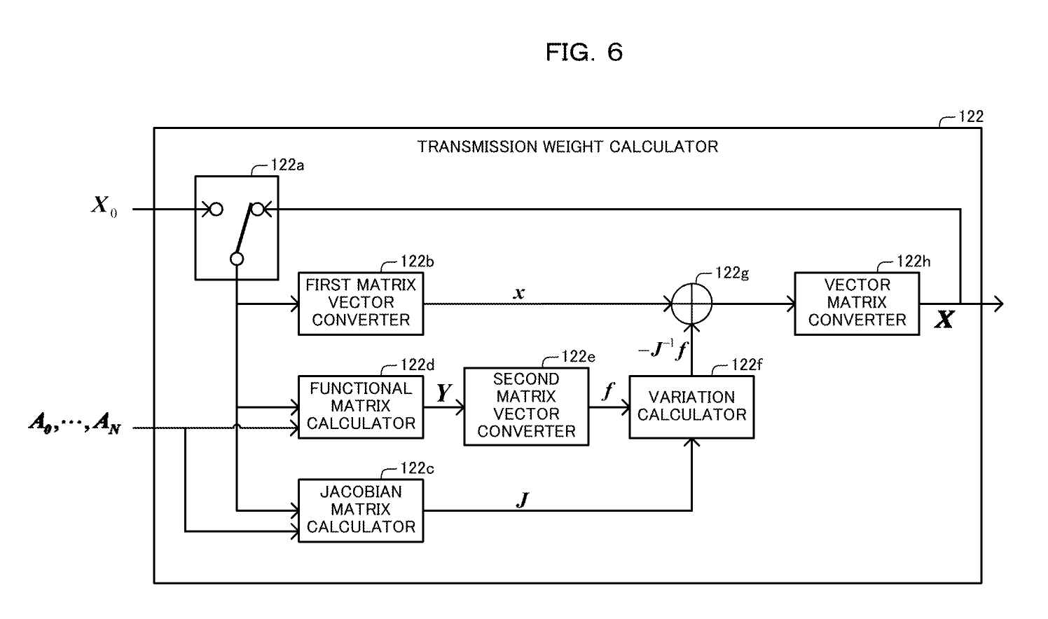

As illustrated in the example of FIG. 6, the transmission weight calculator 122 includes a switch 122a, a first matrix vector converter 122b, a Jacobian matrix calculator 122c, a functional matrix calculator 122d, second matrix vector converter 122e, variation calculator 122f, an adder 122g, and a vector matrix converter 122h.

The switch 122a inputs, when the transmission weight calculator 122 has not calculated the matrix X yet, the predetermined initial value X₀ into the first matrix vector converter 122b, the Jacobian matrix calculator 122c, the functional matrix calculator 122d. The transmission weight calculator 122 stores therein the initial value X₀ in advance.

In contrast, the switch 122a inputs, when the transmission weight calculator 122 has calculated the matrix X, the matrix X converted by the vector matrix converter 122h into the first matrix vector converter 122b, the Jacobian matrix calculator 122c, the functional matrix calculator 122d.

Into the Jacobian matrix calculator 122c and the functional matrix calculator 122d, matrices A₀, . . . , A_{N} having propagation channels represented by the information notified from the first receiver 21 as the elements are input.

The functional matrix calculator 122d calculates the matrix Y using Expression 31 and the input matrices X and A₀, . . . , A_{N}.

The Jacobian matrix calculator 122c calculates a Jacobian matrix J using the input matrices X and A₀, . . . , A_{N} as will be detailed below.

The first matrix vector converter 122b converts the input matrix X into a vector x using Expressions 39-43.

The second matrix vector converter 122e converts the functional matrix Y calculated by the functional matrix calculator 122d into the functional vector f using Expression 40-43.

The variation calculator 122f calculates a variation amount vector using the function vector f converted by the second matrix vector converter 122e and the Jacobian matrix calculate by the Jacobian matrix calculator 122c. The variation amount vector is represented by −J⁻¹f obtained by multiplying −1 and each element of the product of the inverse matrix J⁻¹ of the Jacobian matrix J and the function vector f.

The adder 122g calculates the sum of the vector x converted by the first matrix vector converter 122b and the variation amount vector −J⁻¹f calculated by the variation calculator 122f. The calculated sum is regarded as the vector x.

The vector matrix converter 122h converts the vector x calculated by the adder 122g into matrix X using Expressions 39 and 43.

In the above manner, the transmission weight calculator 122 calculates the matrix X based on the initial value X₀ in the first-time calculation of the matrix X, and in the second- and the subsequent-time calculation, calculates the matrix X based on the matrix X calculated in the previous-time calculation. Furthermore, when the calculated matrix X converges, the transmission weight calculator 122 calculates the transmission weight based on Expression 23 using the calculated matrix X as the solution for the equation represented by Expression 24.

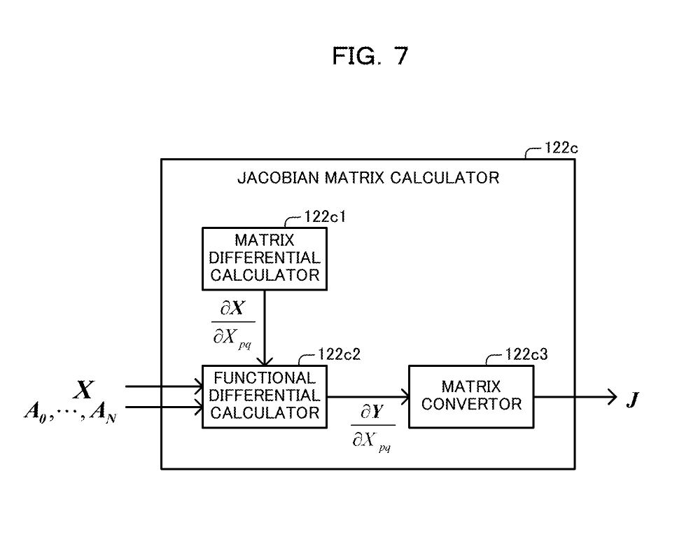

The description will now be made in relation to calculation of a Jacobian matrix J by Jacobian matrix calculator 122c. As illustrated in the example of FIG. 7, the Jacobian matrix calculator 122c includes a matrix differential calculator 122c1, a functional differential calculator 122c2, and a matrix convertor 122c3.

The matrix differential calculator 122c1 calculates the differential of the matrix X for the element X_{pq} in the p-th row and the q-th column of the matrix X based on Expression 35. The matrix differential calculator 122c1 calculates the differential of the matrix X for all the combinations of p and q.

The functional differential calculator 122c2 calculates the differential of the functional matrix Y for the element X_{pq} in the p-th row and the q-th column of the matrix X using Expression 38, the differentials calculated by the matrix differential calculator 122c1, and the input matrices X and A₀, . . . , A_{N}. The functional differential calculator 122c2 calculates the differentials of the functional matrix Y for all the combinations of p and q.

The matrix convertor 122c3 converts the differentials of the functional matrix Y calculated by the functional differential calculator 122c2 into a Jacobian matrix J using Expressions 41-43. Thereby, the Jacobian matrix calculator 122c calculates the Jacobian matrix J.

In this embodiment, the Jacobian matrix calculator 122c calculates a Jacobian matrix by calculating the product and the sum of matrices in the above manner. Advantageously, the Jacobian matrix can be calculated easily.

(Operation)

Next, description will now be made in relation to operation of the wireless communication system 1.

The first receiver 21 measures the propagation channels between the transmission antennas T21 and T22 included in the second transmitter 12 and the receiving antennas R11 and R12 included in the first receiver 21 beforehand. Then the first receiver 21 transmits information representing the measured propagation channel to the second transmitter 12.

Next, the second transmitter 12 calculates the transmission weights on the basis of the propagation channels represented by the notified information and retains the calculated transmission weights.

The second transmitter 12 transmits signals obtained by multiplying a known signal by the retained transmission weights from the two transmitting antennas T21 and T22.

Consequently, the second receiver 22 receives a signal obtained by multiplying the known signal by the transmission weights via the receiving antenna R21. Then, the second receiver 22 estimates the weighed propagation channels on the basis of the received signal and the known signal and subsequently calculates the reception weights on the basis of the estimated weighed propagation channels.

Furthermore, the second transmitter 12 transmits transmission signals multiplied by the retained transmission weights via the transmission antennas T21 and T22. In this embodiment, a transmission signal multiplied by the transmission weight is also referred to as a second signal S2.

Thereby, the second receiver 22 receives a signal from the second transmitter 12 via the receiving antenna R21 and demodulates the received signal by multiplying the received signal by the calculated reception weights.

The first transmitter 11 transmits a first signal S1 via the two transmitting antennas T11 and T12 in the first communication scheme. The first receiver 21 responsively receives the first signal S1, transmitted from the first transmitter 11, via the two receiving antennas R11 and R12 in the first communication scheme.

As described above, the wireless communication system 1 of the first embodiment includes the multiple transmission antennas T21 and T22, the multiple receiving antennas R11 and R12, and the transmission weight calculator 122. The transmission weight calculator 122 controls the transmission weight for a signal to be transmitted from the transmission antennas T21 and T22 using the weight matrix W.

The weight matrix W is a matrix that becomes a null function when being multiplied by a block matrix. A block diagram includes multiple matrices, in the form of blocks, obtained by selecting elements corresponding to the number of transmission antennas T21 and T22 from a channel matrix representing the multiple propagation channels between the multiple transmission antennas T21 and T22 and the multiple receiving antennas R11 and R12.

Consequently, in states where the second signal S2 is transmitted via the multiple transmission antennas T21 and T22 and is then received via the receiving antenna R21, it is possible to inhibit the quality of the first signal S1 received via the receiving antennas R11 and R12 from lowering.

In the wireless communication system 1 of the first embodiment, the multiple propagation channels include propagation channels for the respective propagation paths to propagate signals between the multiple transmission antennas T21 and T22 and the multiple receiving antennas R11 and R12.

This can reflect the propagation channels for the multiple propagation paths in the transmission weight. Accordingly, it is possible to inhibit the quality of the first signal S1 received via the receiving antennas R11 and R12 from lowering.

In the wireless communication system 1 of the first embodiment, the multiple propagation channels includes a propagation channel between each of the multiple transmission antennas T21 and T22 and each of the multiple receiving antennas R11 and R12.

This can reflect the propagation channels between the transmission antennas T21 and T22 and the receiving antennas R11 and R12 in the transmission weight. Accordingly, it is possible to inhibit the quality of the first signal S1 received via the receiving antennas R11 and R12 from lowering.

In the wireless communication system 1 of the first embodiment, the solution for the equation represented by Expression 24 is determined by solving the same equation in the Newton's method.

This can easily determine the transmission weight.

In the wireless communication system 1 of the first embodiment, the differential of the functional matrix Y(X) for the element X_{pq} in the p-th row and the q-th column of the matrix X is calculated using Expression 38. Furthermore, the differential of the element Xₘₙ of an m×n matrix for the element X_{pq} in the p-th row and the q-th column of the matrix X is calculated using Expression 35.

This means that the calculating the product and the sum of matrices can calculate the differential of each of the elements of the matrix X of the left side of the equations represented by Expression 24. Consequently, it is possible to easily calculate a Jacobian matrix J, which is used in Newton's method, and to easily determine the transmission weight.

Here, the second transmitter 12 may simultaneously transmit multiple different signal elements by using each column of a weight matrix as a transmission weight. This can increase an amount of information communicated in a unit time.

The second transmitter 12 may also have the function of the second receiver 22. In contrast, the second receiver 22 may also have the function of the second transmitter 12.

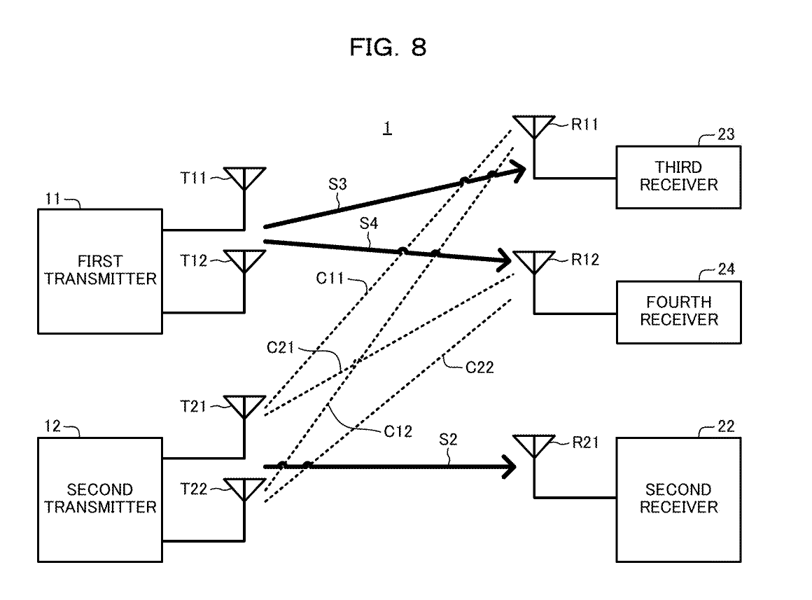

Alternatively, as illustrated in FIG. 8, the wireless communication system 1 may include, in place of the first receiver 21, a third receiver 23 and a fourth receiver 24 respectively including receiving antennas R11 and R12.

In this modification, the first transmitter 11 transmits a third signal S3 and a fourth signal S4 via the two transmitting antennas T11 and T12 in the first communication scheme. The third receiver 23 receives the third signal S3 transmitted from the first transmitter 11 via the receiving antenna R11 in the first communication scheme; and the fourth receiver 24 receives the fourth signal S4 transmitted from the first transmitter 11 via the receiving antenna R12 in the first communication scheme.

In this modification, the third signal S3 and the fourth signal S4 have the same frequency as that of the second signal S2 and are transmitted in parallel (e.g., simultaneously) with each other.

Also in this modification, the wireless communication system can inhibit the quality of the third signal S3 received via the receiving antenna R11 from lowering and also inhibit the quality of the fourth signal S4 received via the receiving antenna R12 from lowering.

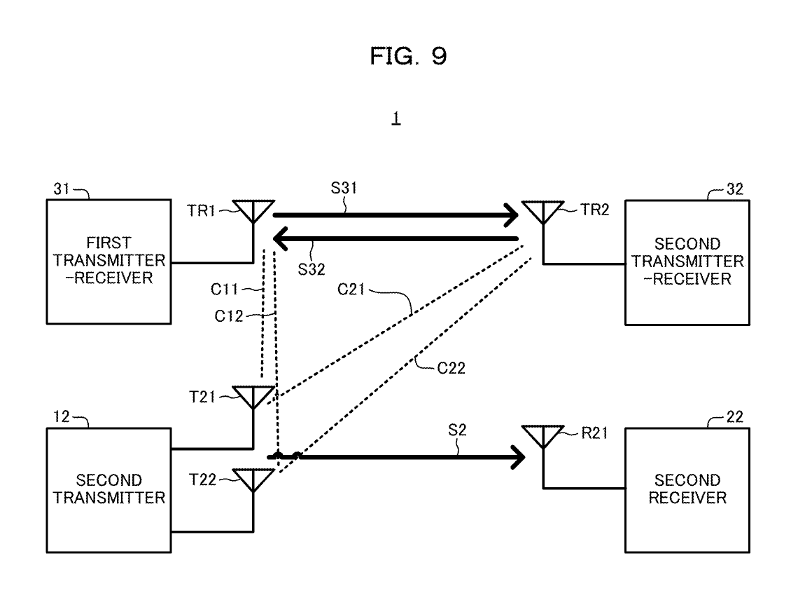

Further alternatively, as illustrated in FIG. 9, the wireless communication system 1 may include a first transmitter-receiver 31 including a transmitting-receiving antenna TR1 and a second transmitter-receiver 32 including a transmitting-receiving antenna TR2.

The first transmitter-receiver 31 transmits a third signal S31 from the transmitting-receiving antenna TR1 in the first communication scheme and receives the fourth signal S34, transmitted from the second transmitter-receiver 32, via the transmitting-receiving antenna TR1 in the first communication scheme. Likewise, the second transmitter-receiver 32 transmits the fourth signal S32 via the transmitting-receiving antenna TR2 in the first communication scheme and receives the third signal S31, transmitted from the first transmitter-receiver 31, via the transmitting-receiving antenna TR2 in the first communication scheme.

In this second modification, the third signal S31 and the fourth signal S32 have the same frequency as that of the second signal S2 and are transmitted in parallel (e.g., simultaneously) with each other.

In other words, the first transmitter-receiver 31 and the second transmitter-receiver 32 carry out full duplex communication in the first communication scheme.

Also in this case, the wireless communication system 1 can inhibit the quality of the third signal S31 received by the transmitting-receiving antenna TR2 from lowering and can also inhibit the quality of the fourth signal S32 received by the transmitting-receiving antenna TR1 from lowering.

### Second Embodiment

Next, a wireless communication system according to a second embodiment will now be described. The wireless communication system of the second embodiment is different from that of the first embodiment in the point that the second transmitter estimates the propagation channels in the second embodiment. Hereinafter, the description will focus on the difference. Like reference numbers designates the same and substantially the same elements and parts in the first and the second embodiments.

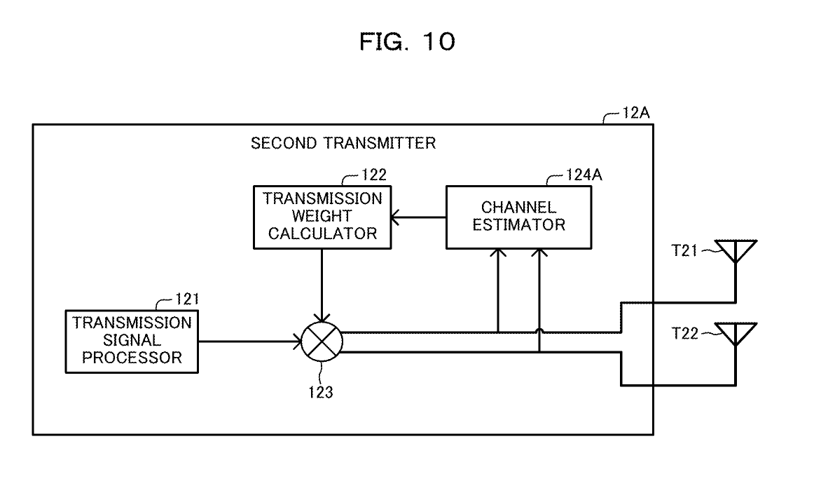

For example, as illustrated in FIG. 10, the wireless communication system 1 of the second embodiment includes a second transmitter 12A in place of the second transmitter 12 of FIG. 3.

The second transmitter 12A of this embodiment is movable. For example, the second transmitter 12A may be carried by the user or may be installed in a mobile article, such as a vehicle. Alternatively, the first receiver 21 may be movable in place of or in addition to the second transmitter 12A.

In the second embodiment, the propagation channels between the transmission antennas T21 and T22 included in the second transmitter 12A and the receiving antennas R11 and R12 included in the first receiver 21 are susceptible to fluctuation as time passes. Considering the above, the second transmitter 12A of the second embodiment estimates the propagation channels between the transmission antennas T21 and T22 included in the second transmitter 12A and the receiving antennas R11 and R12 included in the first receiver 21. Then the second transmitter 12A calculates the transmission weight based on the estimated propagation channels.

The second transmitter 12A further includes a channel estimator 124A in addition to the configuration of the transmitter 12 illustrated in FIG. 4.

The channel estimator 124A estimates the propagation channels between the transmission antennas T21 and T22 included in the second transmitter 12A and the receiving antennas R11 and R12 included in the first receiver 21.

In this embodiment, the first receiver 21 has the function of the first transmitter 11 and uses the receiving antennas R11 and R12 as transmitting antennas. Furthermore, the second transmitter 12A includes the function of the second receiver 22 and uses the transmission antennas T21 and T22 as receiving antennas.

The first communication scheme of the second embodiment is the Time Division Duplex (TDD) scheme. In this case, the propagation channels between the transmission antennas T21 and T22 included in the second transmitter 12A and the receiving antennas R11 and R12 included in the first receiver 21 are common in both directions.

If the first receiver 21 transmits a known signal via the receiving antennas R11 and R12, the channel estimator 124A estimates the propagation channels using a signal received via the transmission antennas T21 and T22 and the known signal. In the second embodiment, a known signal is a signal previously known to both the first receiver 21 and the second transmitter 12A.

The transmission weight calculator 122 calculates the transmission weight based on the propagation channels estimated by the channel estimator 124A.

The above manner allows the wireless communication system 1 of the second embodiment to obtain the same results and advantages as those of the first embodiment.

Furthermore, even in cases where the propagation channels fluctuate as time passes, the wireless communication system 1 of the second embodiment can inhibit the quality of the first signal S1 received via the receiving antennas R11 and R12 from lowering.

Thereby, it is possible to suppress lowering of the quality of a received signal.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A wireless communication system comprising:
a plurality of transmitting antennas;
one or more receiving antennas; and
a controller that controls, based on a weight matrix, a weight on a signal to be transmitted from the plurality of transmitting antennas, the weight matrix coming to be a null matrix when being multiplied by a block matrix, the block matrix having, as blocks, a plurality of matrices obtained by selecting elements corresponding to a number of the plurality of transmitting antennas from a channel matrix representing a plurality of propagation channels between the plurality of the transmitting antennas and the one or more receiving antennas.

2. The wireless communication system according to claim 1, wherein the weight matrix is a block matrix having, as blocks, a plurality of powers of a matrix having elements corresponding to the number of the plurality of transmitting antennas, the plurality of powers having different exponents.

3. The wireless communication system according to claim 1, wherein the plurality of propagation channels include a propagation channel for each propagation path to propagate a signal between the plurality of transmitting antennas and the one or more receiving antennas.

4. The wireless communication system according to claim 3, wherein the plurality of propagation channels include a propagation channel between each of the plurality of transmitting antennas and each of the one or more receiving antennas.

5. The wireless communication system according to claim 4, wherein
the one or more receiving antennas are a plurality of the receiving antennas; and
the weight matrix is a block matrix having, as blocks, a plurality of powers of a matrix representing a solution for an equation concerning a matrix X having an unknown variable as an element and being represented by an Expression 44, the plurality of powers having different exponents,
$${\sum }_{i = 0}^{N} {A}_{i} {X}^{i} = 0 \qquad [ Expression 44 ]$$
where,
N represents a value obtained by subtracting one from a number of the plurality of propagation paths,
i represents an integer among zero through N,
Aᵢ represents an N_{RX}×N_{TX} matrix of the i-th propagation path,
N_{RX} represents a number of the plurality of receiving antennas,
N_{TX} represents a number of the plurality transmitting antennas,
an element in a u-th row and a v-th column of the Aᵢ represents a propagation channel between a u-th receiving antenna among the plurality of receiving antennas and a v-th transmitting antenna among the plurality of transmitting antennas,
u represents an integer among one through N_{RX}, and
v represents an integer among one through N_{TX}.

6. The wireless communication system according to claim 5, wherein the solution is determined by solving the equation using a Newton's method.

7. The wireless communication system according to claim 6, wherein in the Newton's method,
a differential of a left side of the equation for an element X_{pq} in a p-th row and a q-th column of the matrix X using an Expression 45, and
a differential of an element Xₘₙ in an m-th row and an n-th column of the matrix X for an element X_{pq} in an p-th row and an q-th column of the matrix X using an Expression 46, m, n, p, and q each representing an integer of one to N_{TX}.
$$\begin{matrix}\frac{\partial }{\partial {X}_{pq}} \{ {\sum }_{i = 0}^{N} {A}_{i} {X}^{i} \} = {\sum }_{i = 0}^{N} {A}_{i} {\sum }_{j = 1}^{i} {X}^{i - j} \frac{\partial X}{\partial {X}_{pq}} {X}^{j - 1} & [ Expression 45 ] \\ \frac{\partial {X}_{mn}}{\partial {X}_{pq}} = \{ \begin{matrix}1 & ( m = p and n = q ) \\ 0 & ( m \neq p or n \neq q )\end{matrix} & [ Expression 46 ]\end{matrix}$$

8. The wireless communication system according to claim 1, wherein:
the one or more receiving antennas are a plurality of the receiving antennas; and
the wireless communication system further comprises a plurality of receivers including the plurality of receiving antennas, respectively.

9. The wireless communication system according to claim 8, wherein the plurality of receivers carry out full duplex communication.

10. A method for wireless communication comprising:
obtaining a weight matrix coming to be a null matrix when being multiplied by a block matrix, the block matrix having, as blocks, a plurality of matrices obtained by selecting elements corresponding to a number of a plurality of transmitting antennas from a channel matrix representing a plurality of propagation channels between the plurality of the transmitting antennas and one or more receiving antennas; and
controlling, based on the obtained weight matrix, a weight on a signal to be transmitted from the plurality of transmitting antennas.

11. A transmitter comprising:
a plurality of transmitting antennas; and
a controller that controls, based on a weight matrix, a weight on a signal to be transmitted from the plurality of transmitting antennas, the weight matrix coming to be a null matrix when being multiplied by a block matrix, the block matrix having, as blocks, a plurality of matrices obtained by selecting elements corresponding to a number of the plurality of transmitting antennas from a channel matrix representing a plurality of propagation channels between the plurality of the transmitting antennas and one or more receiving antennas.
